(19) United States
(12) Patent Application Publication
(10) Pub. No.: US 2002/0158755 A1
(43) Pub. Date: Oct. 31, 2002

(54) Apparatus for flashing vehicle lights to warn of engine stall

(76) Inventor: James Michael Eggiman, Portland, OR (US)

Correspondence Address: J. Michael Eggiman, POB 86096, Portland, OR, 97286, US

(21) Appl. No.: 09/842,379

(22) Filed: Apr. 27, 2001

(51) Int. Cl. B60Q 1/00

(52) U.S. Cl. 340/439; 340/441; 340/425.5; 340/683

(57) ABSTRACT

An apparatus that detects the absence of engine audio pulses, (sounds of a operating engine), for warning of an engine stall. The apparatus is also designed with a initial flashing test cycle to validate it will be operational in the event of an engine stall. The apparatus is connected between the power source of the vehicle, (battery), and the vehicle lights. If an absence of audio pulses is detected, the apparatus generates a flashing signal that causes a switch to alternately connect and disconnect the power source to the vehicle lights to flash the lights for a limited period of time of forty five seconds. The apparatus is connected to the outside of the vehicles operating systems.

### BACKGROUND OF INVENTION

This invention relates to safety apparatus for motor vehicles and, more particularly to an apparatus for flashing vehicle's lights to warn others in following vehicles of the engine stall of the vehicle.

Flashing hazard lights have been standard equipment on motor vehicles for some time. The driver can operate these lights by pressing a switch that is usually located on the steering column, or a close vicinity. Typically, the flashing hazard lights are employed by the driver who is parked adjacent to a road and wishes to alert and warn approaching drivers of the vehicles presence. The lights may also be employed in the case of an engine stall, wherein the vehicle loses power and its rapid deceleration in a traffic lane may cause following vehicles to collide with it. However, most drivers in such an emergency are preoccupied with steering and controlling the stalled vehicle to safety and will not think or have the time to activate the hazard lights. Also because the hazard light switch is not located in the same position in all vehicles the driver may not instantly be able to locate the hazard switch.

Apparatus are known in the art for automatically turning on the hazard lights and for flashing the head lights, taillights, and parking lights as well in the case of an engine stall. U.S. Pat. No. 3,699,415, for example, disclose an apparatus having a switch activated by engine oil pressure. If the ignition is on and the pressure drops because of an engine stall, the apparatus detects the stall and flashes the warning lights while extinguishing the headlights and tail lights of the vehicle. The apparatus, however, does not work well when the engine is cold. Furthermore, the loss of headlights and taillights can be a safety hazard if the vehicle is operating on the roadway at night.

U.S. Pat. No. 3,882,452 discloses an improvement over the previous apparatus by monitoring the vacuum lines of the vehicle in addition to the oil pressure. The improved apparatus also causes the headlights and taillights as well as the hazardflasher lights to flash in the event of an engine stall. Although clearly an improvment over the prior apparatus, the improved apparatus still suffers from a number of drawbacks. The vacuum and oil pressure in the engine may vary while the engine is still running, causing unintentional flashing of the vehicle lights. The constant flashing of the headlights and taillights will also quickly drain the battery of the vehicle so that it cannot be restarted without assistance.

U.S. Pat. No. 4,878,042 is an improvement over all previous art. It monitors the electric pulse of the electric power coil and when the coil pulse drops below a reference voltage or ceases to emit an electric pulse, indicates the vehicle has stalled. Then automatically triggers the apparatus to flash the brake lights for a limited designated period if time at which time the flashing ends.

Although clearly an improvement over the prior apparatuses, it does have limitations. It will not function on Diesel engines, as they require no coil for operation. Although the function an end result are the same, its electronic design is out dated. It requires a high number of electric components to function and could fail. Thus reducing its longevity and purpose as an automotive safety device. It also has no circuitry program to pre-test the apparatus. It must be manually done by the driver, under the hood with automatic transmissions, and with the clutch in manual. Both are an inconvenience to the driver. The redesign employing the audio sensor, and the computer chip containing the program, which now allows the ability to also employ a flashing test cycle. In the parent U.S. Pat. No. 4,878,042 the Summery, paragraph 7 states the invention my also be fabricated in monolithic form on an integrated circuit as known in the art. CPC is the current state-of-the-art for the apparatus for flashing vehicle lights to warn of an engine stall.

### SUMMERY OF THE INVENTION

An object of the invention, therefore, is to provide an improved apparatus for flashing a motor vehicle's lights to warn of engine stall.

Another object of the invention is to provide such an apparatus that detects an absence of the audio pulse of a running-operating engine which has stalled. The detection of the audio pulses allows the invention to be employed in gasoline, diesel and electric motor, vehicles, providing stall protection for all vehicles.

Yet another object of the invention is to limit the flashing interval to assure that the battery of the vehicle maintains a sufficient charge to enable the vehicle to be restarted without assistance. As in the parent U.S. Pat. No. 4,878,042.

Still another object of the invention is to provide such an apparatus that flashes all brake lights of the vehicle to assure that other drivers following behind are warned of the stall. Also in the parnet U.S. Pat. No. 4,878,042.

Yet another object of the invention is to provide the apparatus with a initial test of the operational function of the apparatus to assure that it will function in the event of a stall, by flashing the brake lights for a brief period of time when the ignition circuit is switched to the ON position before starting the engine.

Also to replace the many components with a computer program chip for operation, including a flashing test cycle for validation of the apparatus.

In accordance with these objects, apparatus according to the invention comprises means for detecting an absence of audio pulses from the engine while the ignition circuit is switched on. Signal generating means responsive to these detecting means generates a flashing signal upon signalling by the detecting means of a lack of engine audio pulses. Switch means, coupled between the power source and the vehicle's lights, responds to the flashing signal by alternately connect and disconnect the power source to the lights to flash the lights for a predetermined period of time.

The invention has a number of desirable features. The apparatus is connected to the outside of the vehicle's internal operating circuitry. Meaning, for what ever the cause for the stall situation, the apparatus is not dependent on the vehicle,s circuitry programs to function, with the exception of battery power. Another desirable feature is the Computer Programmed Chip, (CPC) to operate the functions of the apparatus at a high level of dependability and efficiency, thus eliminating the high number of electric components, which could cause failure within the apparatus. Also the feature of the optional initial five second flashing test cycle when the power is switched to ON before ignition is employed, to validate the apparatus is operational in the event of a stalled engine.

The described embodiment is a discrete construction of the invention. The invention is an overall improvement of the previous art and design of U.S. Pat. No. 4,878,042.

The forgoing and other objects, features, and advantages of the invention will become more apparent from the following detailed description of a preferred embodiment which proceeds with reference to the accompanying drawings.

### BRIEF DESCRIPTION OF THE DRAWINGS

FIG. 1 is a block diagram of an apparatus according to the invention.

FIG. 2 is a schematic diagram of one embodiment of the apparatus shown in FIG. 1.

### DETAILED DESCRIPTION

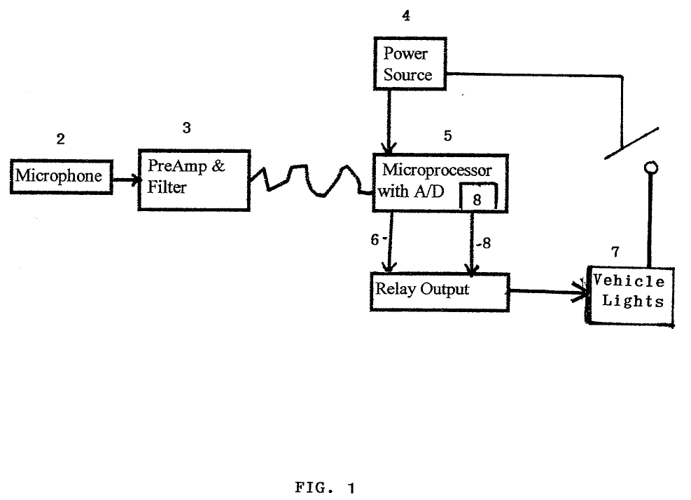

Referring to the drawings, FIG. 1 is a block diagram of a warning apparatus according to the invention. The microphone/audio sensor 2 is located in the engine compartment and in fashion attached to a low heat area of the engine. It picks up local sounds such as engine combustion, rotating belts, road noise wind, etc. The pre-amp and filter 3 circuitry removes some of the unwanted noise while boosting the sounds of associated with the running engine. The microprocessor 5 (such as a PIC processor manufactured by Micro Chip) converts the analog sound imput into a digital value. The power source 4 is the vehicles battery. The power source 4 powers the apparatus and the relay output 6 alternately connects and disconnects the power to the vehicle lights 7 which are negative ground. 8 is the flashing test cycle program, by which the power source is switched on, powers the microprocessor to operate the relay to alternately connect and disconnect the power source to the vehicle light/s to flash the light/s for a predetermined period of time, then ending. 8 is a separate test program of the apparatus within the Micro Chip and not dependent on the stall audio sensing program.

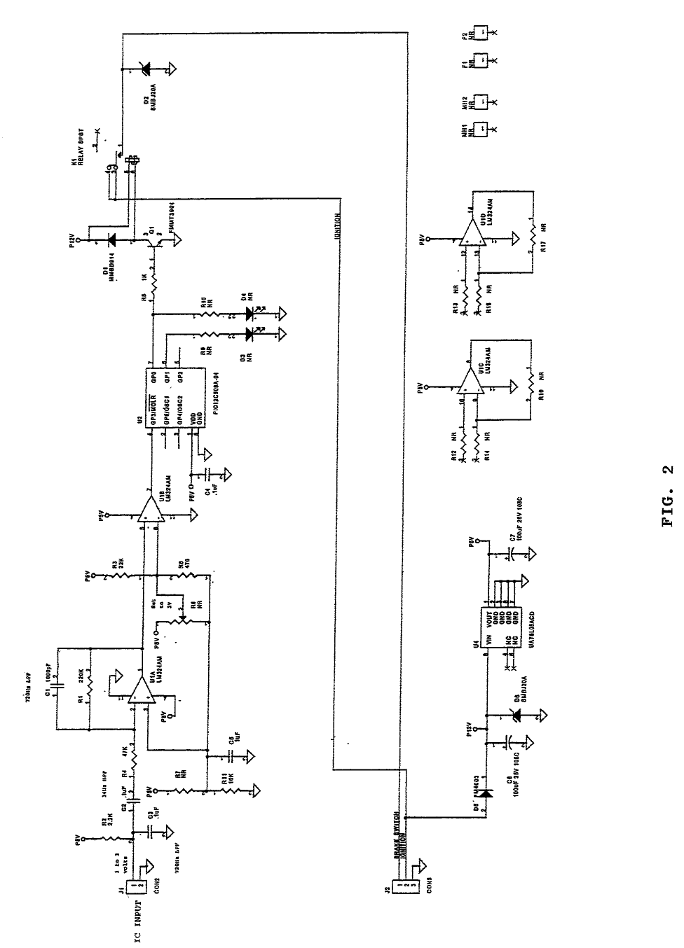

FIG. 2 is a schematic diagram of one of embodiment of the apparatus shown in FIG. 1. The microphone requires a voltage bias provided by R2 in order for it to operate. The microphone signal is amplified op amp U1A. The gain is determined by R1 divided by R4. C1 limit the high frequency response of the amplifier to 720 Hertz. R4 and C2 limit the low frequency response to 34 Hertz. U1B is used as a comparator. R3, R8 and R11 bias the input of U1A and establishes the threshold voltage on pin 6 of U1B. When pin 5 of U1B exceeds the threshold on pin 6 the output, pin 7, goes high. The processor is constantly checking pin 4 to see if it goes high. Once it sees this line go high it assumes that the vehicles engine is running. If it ever fails to receive pulses from the comparator it assumes the vehicle has stalled and it begins turning the relay on and off. It flashes the relay for 45 seconds. If the engine is restarted during the 45 seconds, it stops flashing.

The relay is driven by a 3904 npn transistor. The D1 is a clamp diode to prevent inductive spikes from the relay coil from harming the transistor. The relay connects the ignition wire of the vehicle to the brake light wire. D2 is a transient suppression diode to protect the relay.

Power for the processor is provided by the 78L05 linear voltage regulator. Its input is protected with D6. D5 provides polarity protection and C6 is a power supply filter as is C7. U1D and associated resistors are unused. We claim:

1. Apparatus for flashing vehicle lights to warn of an engine stall, of a vehicle employing an audio monitoring circuit for generating an audio pulse while the engine is running and a power source for powering the vehicle, comprising:
detecting means for detecting an absence of the audio pulses while the ignition circuit is switched on;
signal generating means responsive to the detecting means for generating a flashing signal upon signalling by the detecting means of a lack of engine audio pulses; and
switch means coupled between the power source and the vehicle light and responsive to the flashing signal for alternately connecting and disconnecting the power source to the light to flash the light.

2. The apparatus of claim 1 in which the signal generating means is constructed to respond to the signalling by the detecting means after said signalling persists for a predetermined time.

3. The apparatus of claim 1 including interval means for disabling the flashing signal after a predetermined interval of flashing.

4. The apparatus of claim 3 including discharge means for disabling the flashing signal immediately if the ignition is switched OFF or if engine is restarted.

5. The apparatus of claim 1 including reset means for disconnecting power from the apparatus after the ignition circuit is switched OFF.

6. The apparatus of claim 1 in which the detecting means comprises:
means for generating a trigger audio signal whose level varies in response to the absence of the audio pulse;
means for generating a reference audio pulse; and a trigger comparator for comparing the trigger signal against the reference audio pulse, the comparator output coupled to the signal generating means to cause the means to generate the flashing signal if the trigger signal level crosses the reference audio pulse level for a predetermined time.

7. The apparatus of claim 6 in which the audio signal generating means comprises of a stable audio output from the ignition of a vehicle operating engine.

8. The apparatus of claim 1 in which the audio monitoring circuit means
comprises;
a computer programmed chip, (CPC) which controls the means for detecting both the presents of engine audio pulses and the absence of audio pulses, initiating the activation of the flashing cycle and reset means;
the absence of a engine audio pulse results in the CPC to activate the flashing cycle of the vehicle light, with the use of the relay which is coupled between the power source and the vehicle light and responsive to the CPC to switch power for connecting and disconnecting the power source of the vehicle light/s connected to the relay.

9. The apparatus of claim 1 in which the vehicle light is the Brake Light/s.

10. The apparatus of claim 1 in which the audio detecting circuit is the ignition audio of a running-operating engine. The means for detecting a vehicles operating engine audio pulses is a audio sensor attached to the engine leading from the apparatus, for detection of and lack of, engine audio pulses.

11. The apparatus of claim 3 in which the interval means, comprises:
means for generating an interval signal whose level varies in response to the absence of audio pulses. The level of the interval signal dropping below a predetermined level after the interval of audio pulses drops, the flashing signal is generated for the predetermined time of forty five seconds.

12. The apparatus of claim 8 in which the reset means; comprises:
a reference audio level;
the CPC monitors and references the circuit by means of recognizing and deciphering input and when the power is switched off. A relay coupled to the output of the audio and responsive to the output for disconnecting the power source from the apparatus when the power source from the apparatus when the ignition circuit is switched off.

13. Apparatus of claim 10 employs an audio sensor which detects enginge noise and converts through the CPC into electronic pulses while the engine is running and a power source for powering the vehicle light/s, and sets in operation to generate the flashing signal if the trigger signal level crosses the reference audio pulse level at a lower value, or is absent, and switch means:
coupled between the power source and the vehicle light and the relay responsible the flashing signal for alternately connecting and disconnecting the power source to the light to flash the light/s.

14. The apparatus of claim 13 is controlled and monitored through the CPC for resetting the function to disable the flashing signal after the predetermined period of time. If restarting engine fails, the flashing cycle is reset for another predetermined period of time.

15. Independent claim 1.
The apparatus of claim 8 has an optional additional, but separate program, means;
the CPC initiates a pre-operational flashing test cycle for a limited duration of 5 seconds, when the power circuit is switched ON prior to the ignition start position, means;
powering the relay to alternately connect and disconnect the power source to the vehicle lights, to validate the function of the apparatus of claim 1, without the input function of the audio sensor CPC program of the apparatus.

16. Independent claim 2.
The apparatus of claim 1 is independently connected to the outside of the vehicles operational circuitry, requiring only a 12 volt battery for powering the apparatus, means;
the positive power wire of the apparatus is coupled to the heater fuse with a fuse connector, as to power the apparatus, when the key is in either the ON or Start position, but not in the accessary position. The brake/relay wire of the apparatus is connected to the negative side of the brake switch. The activation of the brake negates the flashing of the brake light/s if applied while the stall program is operating. The ground wire of the apparatus is connected to a common ground on the vehicle. The audio/sensor of the apparatus is placed in close proximity to the engine or motor of the vehicle, means;
Apparatus if claim 1 is independent of the vehicles operating systems, excluding the power source/battery, but will function in the event of a failure of all systems beyond the power source causing a stall situation.
